(19) United States
(12) Patent Application Publication
(10) Pub. No.: US 2021/0095958 A1
(43) Pub. Date: Apr. 1, 2021

(54) ORIENTATION SENSING

(71) Applicant: HEWLETT-PACKARD DEVELOPMENT COMPANY, L.P., Spring, TX (US)

(72) Inventors: Kevin Rourke, Leixlip, Co. Kildare (IE); Ivor Cummins, Leixlip, Co. Kildare (IE); John McNeilly, Leixlip, Co. Kildare (IE)

(21) Appl. No.: 16/606,197

(22) PCT Filed: Oct. 18, 2017
(86) PCT No.: PCT/US2017/057169

§ 371 Date: Oct. 17, 2019

(51) Int. Cl. G01B 17/00; G01F 23/296; G01F 23/26; G01B 7/30; B41J 2/175

(52) U.S. Cl. CPC G01B 17/00; G01F 23/2967; B41J 2002/17583; G01B 7/30; B41J 2/17566; G01F 23/268

(57) ABSTRACT

A fluid container orientation sensor is disclosed. The fluid container orientation sensor may comprise a first vibrational member having a first resonant behaviour and a second vibrational member having a second resonant behaviour. The first vibrational member may be disposed at a first depth within the fluid container. The second vibrational member may be disposed at a second depth within the fluid container A method and a print apparatus are also disclosed.

### BACKGROUND

A user of a fluid container may wish to know how the fluid container is oriented, for example in a scenario where the fluid container is installed in a device. The vibrational behaviour of a vibrating member within a fluid container may provide an insight as to the fluid container's orientation. For example, if the fluid container is tilted such that fluid covers the vibrating member, the vibrational behaviour of the vibrating member may be different than if the fluid container is tilted such that fluid does not cover the vibrating member.

### BRIEF DESCRIPTION OF THE DRAWINGS

Examples will now be described, by way of non-limiting example, with reference to the accompanying drawings, in which:

FIG. 1 is a simplified schematic of an example of a fluid container orientation sensor;

FIG. 2 is a simplified schematic of an example of a fluid container orientation sensor in a fluid container;

FIG. 3 is a simplified schematic of a further example of a fluid container orientation sensor;

FIG. 4 is a simplified schematic of a further example of a fluid container orientation sensor;

FIG. 5 is a simplified schematic of an example of a fluid container orientation sensor mounted to a surface;

FIG. 6 is a simplified schematic of an example of a fluid container orientation sensor and a wall;

FIG. 7 is a simplified schematic of an example of a fluid container orientation sensor in use within a fluid container;

FIG. 8 is a flowchart of an example of a method of determining an orientation parameter;

FIG. 9 is a flowchart of a further example of a method of determining an orientation parameter;

FIG. 10 is a flowchart of a further example of a method of determining an orientation parameter; and

FIG. 11 is a simplified schematic of an example of a print apparatus.

### DETAILED DESCRIPTION

A device is disclosed which can be used to determine a level of fluid in a fluid container and, consequently, may be used to determine information relating to an orientation of the fluid container. The device, which may be considered to be a fluid container orientation sensor, may be installed into a fluid container, such as a print agent container, which may be used in a printing apparatus. The fluid container orientation sensor may function in such a way that its behaviour inside a fluid container can be examined and analysed from outside the fluid container, without a physical (e.g. wired) connection between the sensor and a device or circuitry analysing the sensor's behaviour.

The fluid container orientation sensor 100 comprises a first vibrational member 102 having a first resonant behaviour and a second vibrational member 104 having a second resonant behaviour. The first vibrational member 102 may be disposed at a first depth within the fluid container 110, and the second vibrational member 104 may be disposed at a second depth within the fluid container. The first and second depths may, in some examples, be different to one another. The term “vibrational member”, as used herein, is intended to mean any element or structure capable of exhibiting vibrational behaviour, for example in response to a stimulus or force applied thereto. By analysing a response (e.g. the vibrational behaviour) of the vibrational members in response to a stimulus, it may be possible to determine whether either (or both) of the vibrational members is submerged in a liquid, or disposed in air.

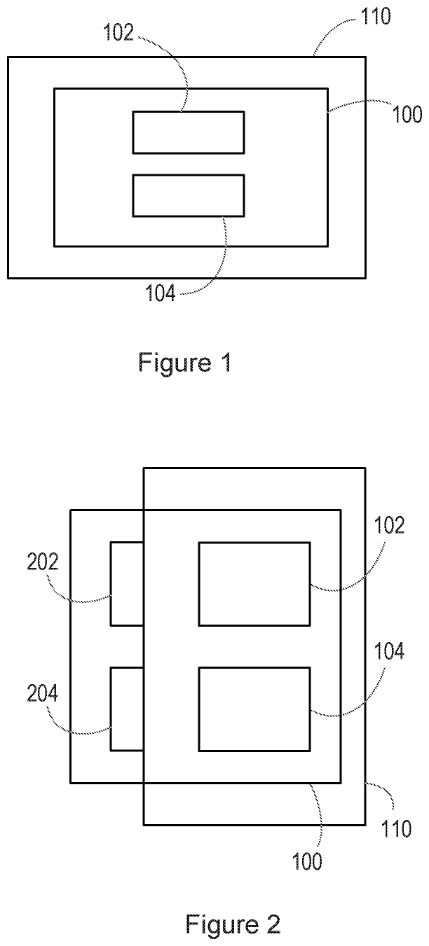

FIG. 1 is a simplified schematic of an example of apparatus for detecting fluid in a fluid container. More specifically, FIG. 1 is a simplified schematic of an example of a fluid container orientation sensor 100 disposed in a fluid container 110. The fluid container 110 may, in some examples, comprise a print agent container to contain print agent. For example, the fluid container 110 may form at least part of an ink cartridge for use in a printing apparatus.

In some examples, the first and second resonant behaviour comprises a natural or resonant frequency of the first and second vibrational members 102, 104, respectively. In other words, the first vibrational member 102 may have a first resonant frequency and the second vibrational member 104 may have a second resonant frequency. If the first and second vibrational members 102, 104 were to vibrate in air, then a significant component of the vibrational response may be at their respective resonant frequencies. However, if the first and second vibrational members 102, 104 were to vibrate in a substance (e.g. while submerged in a liquid such as print agent) then the members may vibrate at frequencies other than their resonant frequencies, or may vibrate at the resonant frequencies, but with heavy damping.

In some examples, the vibrational members 102, 104 may each include an electrical contact. In other examples, the vibrational members 102, 104 may themselves form electrical contacts. For example, the vibrational members 102, 104 may be formed from an electrically conductive material, such as metal. Thus, the first vibrational member 102 may form one plate of a first variable capacitor, and the second vibrational member 104 may form one plate of a second variable capacitor, as is discussed below with reference to FIG. 2.

FIG. 2 is a simplified schematic of a further example of a fluid container orientation sensor 100 disposed in a fluid container 110. According to the example shown in FIG. 2, the fluid container 110 may further comprise a first electrical contact 202 and a second electrical contact 204 disposed outside the fluid container. In this example, the first vibrational member 102 may be capacitively coupled to the first electrical contact 202, and the second vibrational member 104 may be capacitively coupled to the second electrical contact 204. The first and/or second electrical contacts 202, 204 may, in some examples, be disposed on an outer surface of a wall or housing of the fluid container 110. The first electrical contact 202 may be in electrical communication (e.g. capacitively or by a wired connection) with the second electrical contact 204, as discussed below.

In some examples, those electrical contacts disposed within the fluid container 110 (e.g. the first and second vibrational members 102, 104 in the above example), may be disposed on or connected to an inner surface of a wall or housing of the fluid container (e.g. the inner surface of the wall or housing on which the first and second electrical contacts 202, 204 are disposed).

A circuit may be formed via the first and second vibrational members 102, 104 and the first and second electrical contacts 202, 204 as is discussed in greater detail below. The first and second vibrational members 102, 104 may be in electrical communication with one another, for example via a wired connection or via the sensor 100 itself. The first and second electrical contacts 202, 204 may be in electrical communication with one another, for example via a wired connection, via a capacitive coupling, via circuitry (not shown in FIG. 2), or via any combination of these. As noted above, the first vibrational member 102 is in electrical communication with the first electrical contact 202 via a capacitive coupling through a wall (and any gap that may exist between the first vibrational member and the wall) of the fluid container 110, and the second vibrational member 104 is in electrical communication with the second electrical contact 204 via a capacitive coupling through a wall (and any gap that may exist between the first electrical contact and the wall) of the fluid container.

In some examples, those electrical contacts which are disposed outside the fluid container 110 may be remote from (e.g. spaced apart or separated from) the fluid container. However, the electrical contacts 202, 204 which are located outside the fluid container 110 are to be positioned close enough to the vibrational members 102, 104 to maintain a capacitive coupling between them. As discussed below, the vibrational members 102, 104 may be movable relative to the electrical contacts 202, 204. In some examples, in order to maintain a capacitive coupling between the electrical contacts and the vibrational members, the vibrational members 102, 104 may, in their resting positions, be positioned within approximately 4 millimetres of the respective electrical contacts to which they are capacitively coupled.

A capacitance of the circuit formed by the vibrational members and the electrical contacts is variable in response to a stimulus (e.g. a force) applied to the circuit, or to the first vibrational member 102 and/or second vibrational member 104. The circuit may include other electronic components which are not discussed herein.

As noted above, the first electrical contact 102 and the first vibrational member 202 may be considered to be plates of a first variable capacitor and the second electrical contact 104 and the second vibrational member 204 may be considered to be plates of a second variable capacitor. A capacitance of the variable capacitors may be variable in response to a stimulus or force applied to the variable capacitors. For example, a stimulus may be applied to the vibrational members 102, 104, and this may cause a change in the capacitance of the variable capacitors.

The fluid container orientation sensor 100 described above includes first and second vibrational members 102, 104. However, in some examples, the first and second vibrational members may each form part of a separate device which, together, function as a fluid container orientation sensor 100. Each of the devices may sense a fluid level in a fluid container, and responses from two separate devices mounted at different depths within the fluid container may be used to obtain orientation information.

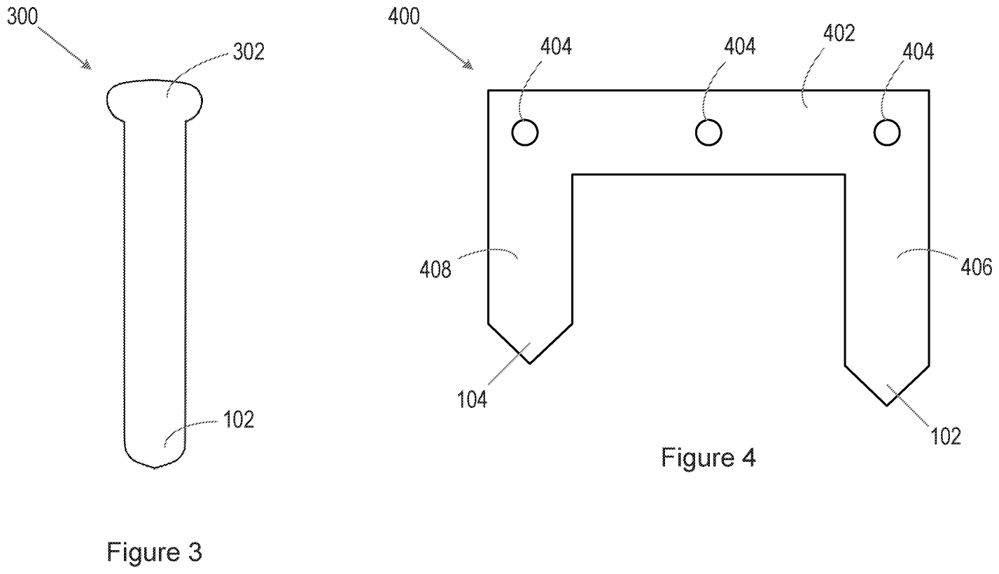

An example of a device 300 for sensing a fluid level in a fluid container is shown in FIG. 3. In the example shown in FIG. 3, the device 300 is generally rectangular (e.g. having a single arm). In other examples, however, as is apparent from the examples below, the device may have a different general shape.

The device 300 may, in some examples, include a mounting portion 302 for mounting the device to a surface, such as the inner surface of a wall or housing of a fluid container. The device 300 may include a vibrational member, such as the first vibrational member 102. In some examples, the mounting portion 302 may be located at or near to a first, proximal end of the device 300 and the first vibrational member 102 may be located at or near to a second, distal end of the device.

A further example of a device 400 for sensing a fluid level in a fluid container is shown in FIG. 4. The device 400 may be considered to be a fluid container orientation sensor. In the example shown in FIG. 4, the device 400 is generally n-shaped (or shaped as an inverted U). The device 400 includes a mounting portion or arm 402 for mounting the device to a surface, such as the inner surface of a wall or housing of a fluid container 110. The mounting portion 402 may include an aperture, or multiple apertures 404, for receiving a peg, screw or the like, for attaching the device to a surface. The device 400 includes two vibrational members, corresponding to the vibrational members 102, 104 shown in FIGS. 1 and 2. In the arrangement of FIG. 4, however, each vibrational member comprises a limb, or arm. Thus, the fluid container orientation sensor 100, 400 may comprise a first arm 406 comprising the first vibrational member 102 and a second arm 408 comprising the second vibrational member 104. As noted previously, each vibrational member may comprise or include an electrical contact, or electrically conductive element. For example, a first electrically conductive element may be located on the vibrational member 102 of the first arm 406 and a second electrically conductive element may be located on the vibrational member 104 of the second arm 408. In the example shown in FIG. 4, the first and second arms 406, 408 extend downwards from the mounting portion or arm 402. In general, however, the arrangement of the device 400 may be such that, in use, the vibrational members 102, 104 (or at least the electrically conductive elements of the vibrational members) are disposed at different depths within a fluid container 110.

In some examples, as shown in the example of FIG. 4, the first arm 406 and the second arm 408 may each have a proximal end and a distal end. The first vibrational member 102 may be positioned at a distal end of the first arm 406, and the first arm may be mounted to the fluid container 110 at its proximal end. The second vibrational member 104 may be positioned at a distal end of the second arm 408, and the second arm may be mounted to the fluid container 110 at its proximal end.

In other examples, the device may be of a shape and/or configuration other than those shown in FIGS. 3 and 4. In general, the device 300, 400 may be formed from any material which allows suitable vibration characteristics to be designed and/or selected. In other words, any material may be used which exhibits a strong vibratory response to a stimulus. Using a metal may further enable an electrical connection to be formed through the device. In some examples, the device 300, 400 may be formed from 301/302 stainless steel. Such a material has strong chemical resistance characteristics. A ferritic material, such as ferritic steel allows for magnetic excitation of the device, as discussed below.

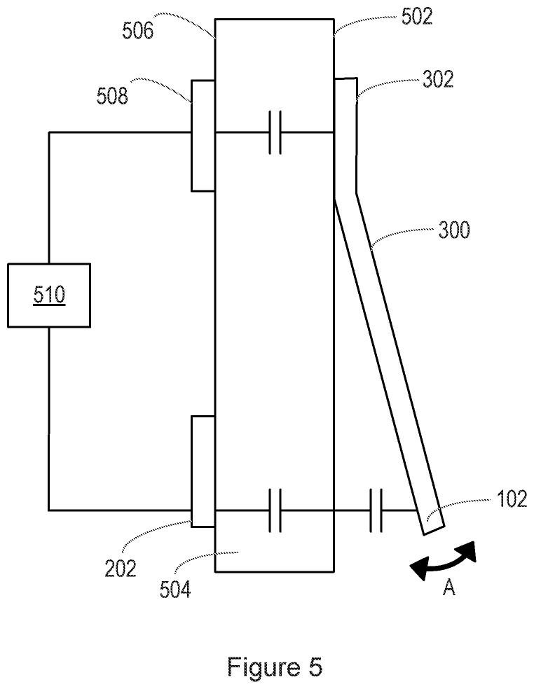

The operation of the fluid container orientation sensor is now discussed with reference to FIG. 5. FIG. 5 is a simplified schematic of an example of a device, such as the single-arm device 300, mounted to a surface, such as surface 502 of a wall 504 of a fluid container. As noted previously, in some examples, multiple single-arm devices 300 may be mounted to the wall 504 of the fluid container 110 in order to function as a fluid container orientation sensor 100. FIG. 5 shows a single device 300, but the following discussion is applicable to each device 300 that might be mounted to the wall 504. The device 300 is mounted to the wall 504 at the mounting portion 302. The device 300, in this example, is substantially planar. The device 300 may, for example, be formed from sheet metal, such as aluminium, stainless steel, or the like. The first vibrational member 102 is located at the distal end of the device 300, and is spaced apart from the wall 504. The distal end of the device 300, including the first vibrational member 102, is moveable relative to the wall 504. In this way, the first vibrational member 102 may move in a direction shown by the arrow A, for example in a vibratory manner, when a stimulus or force is applied to the device 300. Various methods of applying a stimulus or force to the device 300 are discussed herein. In general, however, the stimulus is to cause the first vibrational member 102 (and the second vibrational member 104 and vibrational members of other devices) to move relative to the wall 504 (e.g. oscillate towards and away from the wall).

Electrical contacts may be provided on an outer surface 506 of the wall 504. In the example shown in FIG. 5, the first electrical contact 202 is provided at a position substantially aligned with the first vibrational member 102 (e.g. the end of the arm) of the device 300. As noted above, the first vibrational member 102 may be formed from an electrically conductive material, or may include an electrically conducive element, so as to function as one plate of a variable capacitor. In this way, the first vibrational member 102 and the first electrical contact 202 are capacitively coupled to one another through the wall 504 and through a gap between the wall and the first electrical contact. The proximal end of the device 300 is in electrical communication with an electrical contact 508 formed on the outer surface 506 of the wall 504. In some examples, the proximal end (e.g. the mounting portion 302) of the device may be capacitively coupled to the electrical contact 508, as indicated in FIG. 5. In other examples, a physical electrical connection may exist between the electrical contact 508 and the proximal end of the device 300, for example via mounting elements used to mount the device 300 to the wall 504.

The first electrical contact 202 and the electrical contact 508 may be electrically connected, for example capacitively or physically, with other components or circuitry 510. The circuitry 510 may include processing circuitry, for example for measuring capacitances. In some examples, an air gap and an associated capacitance may be introduced between the electrical contact 508 and the circuitry 510, and/or between the first electrical contact 202 and the circuitry 510. In some examples, the fluid container may comprise a print agent container, such as an ink cartridge. The ink cartridge may be mounted in a carriage to move the ink cartridge over a substrate to be printed. The first electrical contact 202 and the electrical contact 508 may be electrically connected to electrical contacts of the carriage and/or to circuitry associated with a printing apparatus.

A stimulus may be applied to the first vibrational member 102, to the device 300 and/or to the fluid container 110. In some examples, a stimulus may comprise an impulse applied to the first vibrational member 102, the device 300 and/or the container 110. For example, in the print apparatus example, an impulse (e.g. a sudden impact, or brief force) may be applied by causing the carriage carrying the ink cartridge to knock against a surface. In other examples, a stimulus may comprise an electromagnetic pulse, acoustic pulse (e.g. an acoustic radiation force, such as a low frequency vibration, generated by a woofer) or some other force applied to the vibrational member 102, the device 300 and/or the container 110. For example, a magnetic field may be generated for a short period of time, in order to attract the distal end of the device 300 (i.e. the vibrational member 102) in a direction away from the wall 504. Once the magnetic field is deactivated, the distal end (i.e. the vibrational member 102) is released from the magnetic attraction, causing it to return to its original, resting, position. The magnetic field may be generated by a device located remote to the fluid container, for example a magnet, or an electromagnet located in the printing apparatus.

After a stimulus (in any form) has been applied to the first vibrational member 102 of the device, the vibrational member may undergo oscillatory motion as it returns to its resting position. In other words, the first vibrational member 102 may oscillate towards and away from the wall 504 in the direction of the arrow A in FIG. 5, for example in a vibratory manner.

The example shown in FIG. 5 relates to a device 300 having a single vibrational member. In other examples, the device may include additional vibrational members which may move (e.g. with oscillatory motion) relative to a wall of the fluid container in which the device is located. For example, the device 400 shown in FIG. 4 has two vibrational members, namely the first vibrational member 102 (i.e. a distal end of the first arm 406), and the second vibrational member 104 (i.e. a distal end of the second arm 408). Proximal ends of the first and second arms 406, 408 may be connected to the mounting portion or arm 402, as shown in FIG. 4. In other examples, the proximal ends of the arms 406, 408 meet at a common mounting portion. The mounting portion of the device 400 may be mounted to the wall of fluid container, and the distal ends of the arms 406, 408 may be free to move (i.e. vibrate) relative to the wall, for example in the manner described above with reference to FIG. 5. A stimulus or force applied to the device 400 may cause oscillatory motion of both the first and second vibrational member 102, 104, in a manner similar to that described above with reference to FIG. 5.

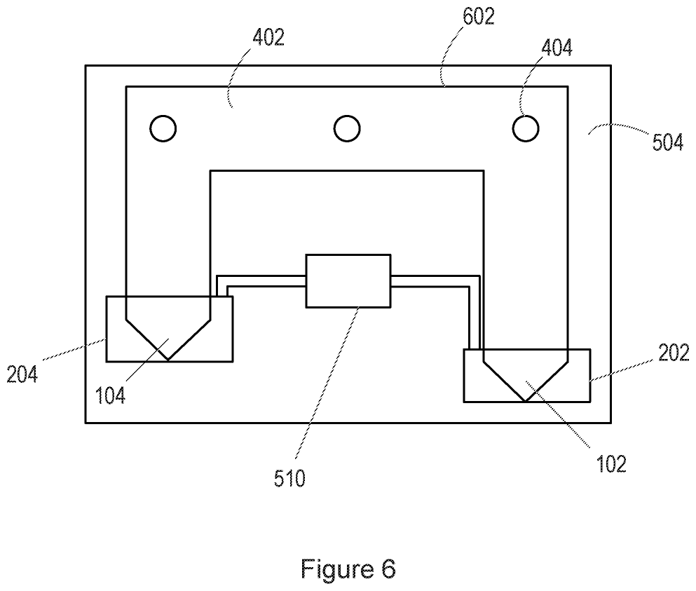

FIG. 6 is a simplified schematic showing an example of the device 400 and a wall 504 of a fluid container 110. The position of the device 400 in a mounted position on the wall is shown by the outline 602. The positions of the first electrical contact 202 and the second electrical contact 204 on the outer surface of the wall 504 are indicated. The circuitry 510 to which the electrical contacts 202, 204 may be connected is also shown. In this example, the mounting portion 402 of the device 400 may not form a direct electrical connection with a contact (e.g. electrical contact 508) formed on the outer surface of the wall 504 in a position aligned with the mounting portion (as in the example of FIG. 5). Instead, a capacitive connection is formed between the first electrical contact 202 outside the fluid container 110 and the first vibrational member 102 of the device 400 (through the wall 504). A capacitive connection is also formed between the second electrical contact 204 outside the fluid container 110 and the second vibrational member 104 of the device 400 (through the wall 504). The first electrical contact 202 and the second electrical contact 204 may be electrically connected, for example capacitively or physically, with other components or circuitry, such as the circuitry 510.

As noted above, when a stimulus is applied to the device 300, 400 or to a fluid container in which the device is disposed, the vibrational members may be caused to oscillate or vibrate relative to the wall 504. As the vibrational members 102, 104 move relative to the wall 504 (and, therefore, relative to the first and second electrical contacts 202, 204 outside the fluid container), the capacitance of the circuit, and particularly of each capacitive coupling, is caused to vary. By measuring the variation in the capacitance (e.g. by measuring a frequency of the change in capacitance in the response) resulting from the movement of the vibrational members 102, 104, it is possible to determine whether each of the vibrational members is submerged in a substance in the fluid container. If the vibrational members 102, 104 are caused to vibrate in air, then they will vibrate at their resonant frequency and, therefore, the frequency of the change in capacitance measured for a vibrational member will be equal to the resonant frequency of that vibrational member. However, if a vibrational member is submerged in a substance, such as print agent, then they will not vibrate at their resonant frequencies, or they will vibrate, but with heavy damping. Thus, if the capacitance changes at a rate corresponding to the resonant frequency of a particular vibrational member 102, 104, then it may be determined that the vibrational member is oscillating in air and, therefore, is not submerged in a liquid, such as print agent.

Movement of the vibrational members 102, 104 may be caused in various ways. In some examples, as discussed above, an impulse may be applied to the device 300, 400 or to the fluid container 110. An impulse may be considered to be a momentary force which causes the free ends of the arms of the device 300, 400 (i.e. the vibrational members) to oscillate or vibrate. By measuring the change in capacitance immediately after (or soon after) the impulse has been applied, it may be possible to determine whether either of the arms (and, therefore, either of the vibrational members 102, 104) is vibrating at its resonant frequency.

In some examples, an impulse, or sudden force, may be applied by causing a moving fluid container containing the device 300, 400 to rapidly decelerate, for example by stopping a carriage housing the fluid container suddenly, or by causing the carriage to knock against a stopping member. As described above, an external device, such as an electromagnet, may be used to generate an impulse force, by generating a magnetic field to act on vibrational members of the device 300, 400, then removing the magnetic field, to cause the vibrational members to oscillate as they return to a resting position.

Another way of causing movement of the vibrational members 102, 104 of the device 300, 400 is to cause movement of the vibrational members at a defined driving frequency. In some examples, a direction of movement of the fluid container may rapidly and repeatedly be reversed. Such movement may be referred to as cyclic movement. For example, a mechanism for causing a carriage to move within a printing apparatus may cause the fluid container 110 to move backwards and forwards, for example along a track, at a defined frequency. Fluid, such as print agent, within the fluid container 110 may be caused to slosh from one side of the fluid container to an opposite side of the fluid container at the same defined frequency. The moving liquid may cause the vibrational members to oscillate at the same frequency. During the movement of the device 300, 400, the capacitance of the circuit may change at a rate corresponding to the driving frequency, and the change in capacitance may be measured, for example by circuitry connected to the device, such as the circuitry 510. If it is determined that a particular vibrational member of the device 300, 400 is vibrating or oscillating at the driving frequency, then it may be determined that the particular vibrational member is submerged, or at least partially submerged, in a liquid.

In some examples, cyclic movement of the device may be caused using a force generated by an external, such as the electromagnet discussed above or an acoustic wave generator, such as a woofer. For example, an electromagnet may be activated and deactivated at a driving frequency so as to cause a magnetic field to act on the device 300, 400, and therefore cause oscillatory movement of the vibrational members 102, 104, at the driving frequency.

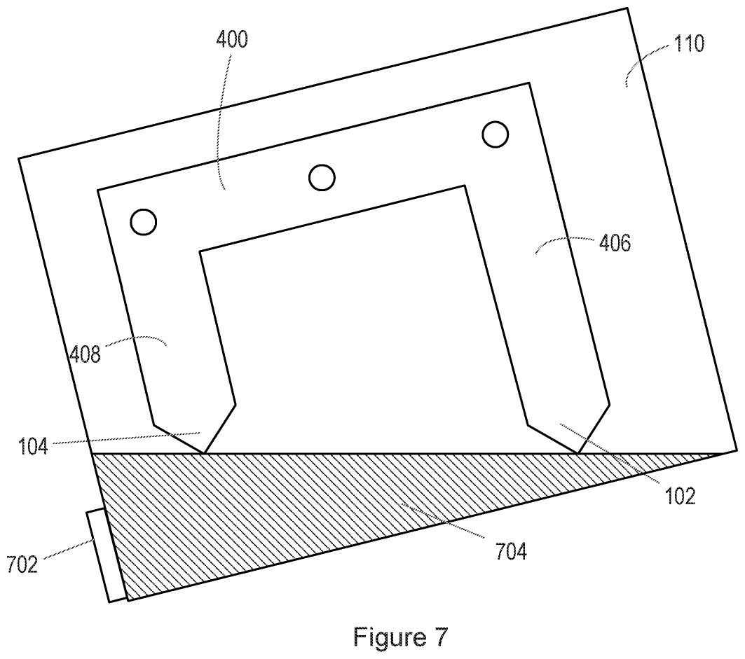

FIG. 7 is a simplified schematic of a fluid container orientation sensor 400 installed in a fluid container 110 (e.g. a print agent container). The fluid container 110 is shown inclined to the horizontal, to represent the intended angle at which such a print agent container may be installed in a printing apparatus. If the printing apparatus is positioned on a horizontal surface, then the print agent container 110 installed in this manner, will be inclined towards one end. The print agent container 110 includes a print agent outlet 702 via which fluid 704 (e.g. print agent) may egress, for example to be deposited onto a printable substrate. The print agent container 110 is intended to be installed in such an inclined orientation to increase the amount of print agent that is able to egress the container. If the printing apparatus is positioned on a non-horizontal surface, or is somehow inclined relative to the horizontal, then the print agent container may be inclined away from the end of the container at which the print agent outlet 702 is located. In such a scenario, print agent may become trapped or stranded in the container 110 and may be wasted.

The fluid container orientation sensor 400 may, in some examples, be mounted in such a way, or the arms 406, 408 may extend to such lengths, that, as the fluid 704 in the fluid container 110 reduces in volume (e.g. as the print agent is used and deposited from the container), the vibrational members 102, 104 of the sensor 400 are uncovered at the same time. In other words, the vibrational members 102, 104 are intended to be at depths within the container 110 such that both vibrational members will begin to vibrate at their resonant frequencies at the same time as the level of print agent 704 in the print agent container 110 reduces.

Thus, in use, a stimulus may be applied to the vibrational members 102, 104, for example at regular intervals, or when it is expected that the level of the fluid 704 is soon to fall level with the bottom of the vibrational members. If a response from the stimulus indicates that both vibrational members 102, 104 have been uncovered by print agent 704 at the same time, then it may be determined that the printing apparatus is installed on a horizontal surface. However, if just one of the vibrational members exhibits a response indicating a change in capacitance at its resonant frequency, then it may be determined that one of the vibrational members has been uncovered before the other vibrational member and, therefore, it may be determined that the printing apparatus is inclined with respect to the horizontal (e.g. not as intended).

In some examples, the sensor 400 may be installed in such a way that the vibrational members 102, 104 are not intended to uncover at the same time as print agent 704 is used. However, in such examples, the offset between the vibrational members may be predetermined and may, for example, be stored in a storage unit associated with the print agent container. If the vibrational members are uncovered in an order or at a time not in line with the predetermined offset, then it may be determined that the printing apparatus is inclined with respect to the horizontal.

If it is determined that the printing apparatus is inclined relative to the horizontal (e.g. by recognizing that the vibrational members are uncovered at different times), then, by counting a number of print agent drops deposited between the uncovering of the two vibrational members, it may be possible to estimate or calculate an angle at which the printing agent is inclined relative to its intended orientation (i.e. horizontal). From a calculation of the actual orientation of the printing apparatus, it may be possible to estimate or calculate an amount of print agent that may be remaining in the print agent container. Such an estimation or calculation may be used to provide a user with a more accurate estimation of the amount of printing that can be achieved with the print agent container before the print agent runs out (e.g. assuming that the printing apparatus is adjusted to be oriented as intended).

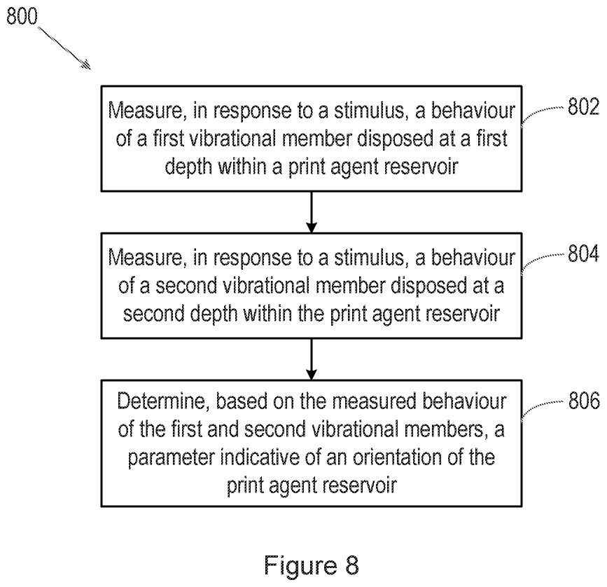

FIG. 8 is a flowchart of an example of a method 800, which may be a method of determining an orientation of a fluid container. The method 800 comprises, at block 802, measuring, in response to a stimulus, a behaviour of a first vibrational member 102 disposed at a first depth within a print agent reservoir. The print agent reservoir may comprise the fluid container, or print agent container 110 discussed herein. At block 804, the method 800 may comprise measuring, in response to a stimulus, a behaviour of a second vibrational member 104 disposed at a second depth within the print agent reservoir 110. The stimulus may, in some examples, comprise a force imparted to the print agent reservoir. The stimulus, or force, may be generated using techniques discussed herein. For example, the force may comprise a force selected from a group comprising: an impulse (e.g. a sudden force applied to the reservoir), an impact (e.g. a sudden physical force applied to the reservoir), a magnetic pulse (e.g. from an electromagnet), and an acoustic pulse (e.g. from a woofer).

Both vibrational members 102, 104 may be provided with the same stimulus. The response may be measured as a change in capacitance, for example using techniques described herein. The measured behaviour may comprise a measured vibrational frequency, indicated, for example, by a rate of change of a capacitance resulting from the movement of the vibrational members.

The method 800 may comprise, at block 806, determining, based on the measured behaviour of the first and second vibrational members 102, 104, a parameter indicative of an orientation of the print agent reservoir 110. The parameter may, in some examples, comprise an angle of inclination of the print agent reservoir 110 or of a printing apparatus in which the print agent reservoir is installed, relative to the horizontal.

In some examples, the first vibrational member 102 may form an electrically conductive element of a first variable capacitor and the second vibrational member 104 may form an electrically conductive element of a second variable capacitor. The measured behaviour of the first vibrational member 102 may comprise a value indicative of a capacitance of the first variable capacitor and the measured behaviour of the second vibrational member 104 may comprise a value indicative of a capacitance of the second variable capacitor. The values may, in some examples, comprise a rate of change of the capacitances, which may correspond to the vibrational frequencies of the first and second vibrational members 102, 104, respectively.

Determining the parameter (block 806) may, in some examples, comprise comparing the measured behaviour of the first vibrational member 102 with a resonance property of the first vibrational member and comparing the measured behaviour of the second vibrational member 104 with a resonance property of the second vibrational member. For example, if the measured behaviour comprises a frequency of vibration of the vibrational members, the measured frequency of each vibrational member may be compared to the resonant frequency of the respective vibrational member. If a vibrational member is determined to be vibrating at its resonant frequency, then it may be determined that the vibrational member is in air, and is not submerged in print agent.

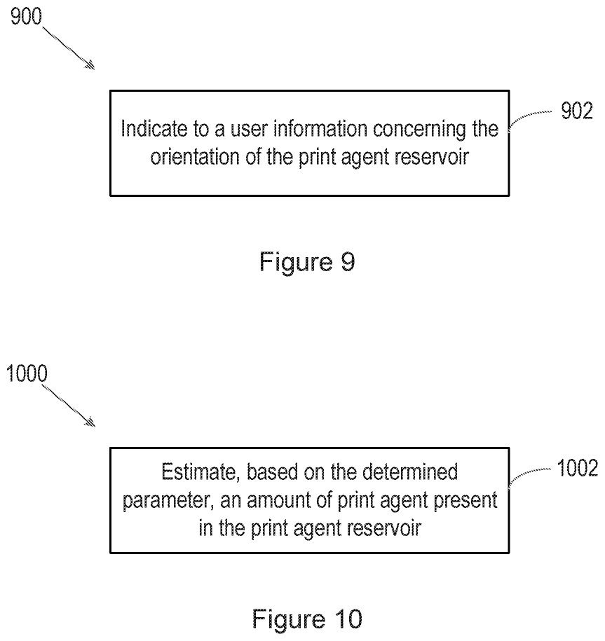

FIG. 9 is a flowchart of a further example of a method 900, which may be a method of determining an orientation of a fluid container. The method 900 may comprise blocks of FIG. 8. The method 900 may comprise, at block 902, indicating to a user information concerning the orientation of the print agent reservoir 110. For example, if it is determined that the print agent reservoir 110 or the printing apparatus in which the reservoir is installed is tilted, or inclined relative an intended reference, such as horizontal, then a user may informed. In some examples, the user may be informed that the printing apparatus should be oriented differently, in order to reduce print agent wastage, for example.

FIG. 10 is a flowchart of a further example of a method 1000, which may be a method of determining an orientation of a fluid container. The method 1000 may comprise blocks of FIGS. 8 and/or 9. The method 1000 may comprise, at block 1002, estimating, based on the determined parameter, an amount of print agent present in the print agent reservoir 110. For example, if the incline relative to its intended orientation can be determined, then the amount of print agent remaining in the print agent container 110 may be determined. The estimated amount may be informed to a user.

A method for manufacturing or constructing a replaceable print apparatus component, such as a print agent container, may comprise providing an orientation sensor and mounting the orientation sensor within a replaceable print apparatus component. The orientation sensor may comprise a first vibrational member having a first resonant behaviour and a second vibrational member having a second resonant behaviour. Mounting the orientation sensor may comprise mounting the orientation sensor within a replaceable print apparatus component such that the first vibrational member is disposed at a first depth within the replaceable print apparatus component and the second vibrational member disposed at a second depth within the replaceable print apparatus component.

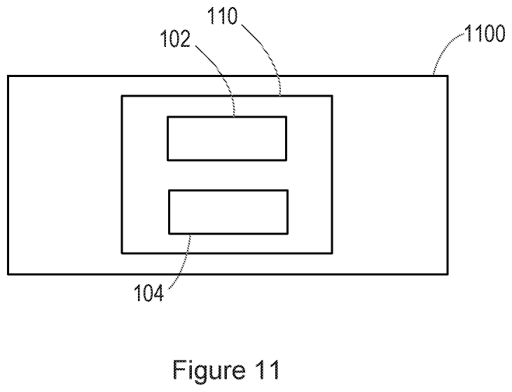

FIG. 11 is a simplified schematic of a print apparatus 1100. The print apparatus 1100 comprises a replaceable print apparatus component 110. The replaceable print apparatus component 110 comprises a first vibrational paddle 102 having a first resonant behaviour, and a second vibrational paddle 104 having a second resonant behaviour. The first vibrational paddle 102 may comprise the first vibrational member and the second vibrational paddle 104 may comprise the second vibrational member. The first vibrational paddle 102 may be disposed at a first depth within the replaceable print apparatus component 110 and the second vibrational paddle 104 may be disposed at a second depth within the replaceable print apparatus component. A measurement of a behaviour of the first and second vibrational paddles 102, 104 in response to a stimulus applied to the first and second vibrational paddles may be indicative of an orientation of the print apparatus. In some examples, the replaceable print apparatus component 110 may comprise a print agent container.

The replaceable print apparatus component 110 may, in some examples, be installed in the print apparatus 1100 in such an orientation that a line between a bottommost part of the first vibrational paddle 102 and a bottommost part of the second vibrational paddle 104 is substantially horizontal. In this way, as the amount of print agent in the component 110 reduces, the first and second vibrational paddles 102, 104 should be uncovered at the same time.

In some examples, the first resonant behaviour may comprise a first resonant frequency and the second resonant behaviour may comprise a second resonant frequency, different to the first resonant frequency. In this way, the response from the first vibrational paddle 102 may be distinguished from the response from the second vibrational paddle 104. Thus, if the paddles 102, 104 are uncovered at different times, it may be possible to determine which paddle uncovers first and, therefore, it may be possible to determine an orientation, inclination or tilt of the replaceable print apparatus component 110 and/or of the print apparatus 110.

In the above examples, capacitive sensing is used to measure the response of the device when a stimulus is applied. In other examples, however, inductive sensing may be used instead of capacitive sensing. For example, movement of a magnet attached to the vibrational members 102, 104 may induce a current in an electromagnetic coil. The frequency component of the response may be measured.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A fluid container orientation sensor comprising:
a first vibrational member having a first resonant behaviour, the first vibrational member disposed at a first depth within the fluid container; and
a second vibrational member having a second resonant behaviour, the second vibrational member disposed at a second depth within the fluid container.

2. A fluid container orientation sensor according to claim 1, wherein the first and second resonant behaviour comprises a resonant frequency of the first and second vibrational members, respectively.

3. A fluid container orientation sensor according to claim 1, further comprising:
a first arm comprising the first vibrational member; and
a second arm comprising the second vibrational member.

4. A fluid container orientation sensor according to claim 3, wherein the first arm and the second arm each have a proximal end and a distal end;
wherein the first vibrational member is positioned at a distal end of the first arm, and the first arm is mounted to the fluid container at its proximal end; and wherein the second vibrational member is positioned at a distal end of the second arm, and the second arm is mounted to the fluid container at its proximal end.

5. A method comprising:
measuring, in response to a stimulus, a behaviour of a first vibrational member disposed at a first depth within a print agent reservoir;
measuring, in response to a stimulus, a behaviour of a second vibrational member disposed at a second depth within the print agent reservoir; and
determining, based on the measured behaviour of the first and second vibrational members, a parameter indicative of an orientation of the print agent reservoir.

6. A method according to claim 5, wherein the first vibrational member forms an electrically conductive element of a first variable capacitor and the second vibrational member forms an electrically conductive element of a second variable capacitor; and
wherein the measured behaviour of the first vibrational member comprises a value indicative of a capacitance of the first variable capacitor and the measured behaviour of the second vibrational member comprises a value indicative of a capacitance of the second variable capacitor.

7. A method according to claim 5, wherein determining the parameter comprises comparing the measured behaviour of the first vibrational member with a resonance property of the first vibrational member and comparing the measured behaviour of the second vibrational member with a resonance property of the second vibrational member.

8. A method according to claim 5, further comprising:
indicating to a user information concerning the orientation of the print agent reservoir.

9. A method according to claim 5, further comprising:
estimating, based on the determined parameter, an amount of print agent present in the print agent reservoir.

10. A method according to claim 5, wherein the stimulus comprises a force imparted to the print agent reservoir.

11. A method according to claim 10, wherein the force comprising a force selected from a group comprising: an impulse, an impact, a magnetic pulse, and an acoustic pulse.

12. A print apparatus comprising:
a replaceable print apparatus component comprising:
a first vibrational paddle having a first resonant behaviour, the first vibrational paddle disposed at a first depth within the replaceable print apparatus component; and
a second vibrational paddle having a second resonant behaviour, the second vibrational paddle disposed at a second depth within the replaceable print apparatus component;
wherein a measurement of a behaviour of the first and second vibrational paddles in response to a stimulus applied to the first and second vibrational paddles is indicative of an orientation of the print apparatus.

13. A print apparatus according to claim 12, wherein the replaceable print apparatus component comprises a print agent container.

14. A print apparatus according to claim 12, wherein the replaceable print apparatus component is to be installed in the print apparatus in such an orientation that a line between a bottommost part of the first vibrational paddle and a bottommost part of the second vibrational paddle is substantially horizontal.

15. A print apparatus according to claim 12, wherein the first resonant behaviour comprises a first resonant frequency and the second resonant behaviour comprises a second resonant frequency, different to the first resonant frequency.
